(19) United States
(12) Patent Application Publication
(10) Pub. No.: US 2012/0287426 A1
(43) Pub. Date: Nov. 15, 2012

(54) PATTERN INSPECTION METHOD AND DEVICE FOR SAME

(76) Inventors: Hideaki Sasazawa, Yokohama (JP); Takenori Hirose, Tokyo (JP); Shigeru Serikawa, Chigasaki (JP); Kiyotaka Horie, Hadano (JP)

(21) Appl. No.: 13/520,217

(22) PCT Filed: Jan. 27, 2011
(86) PCT No.: PCT/JP2011/051632

§ 371 Date: Jul. 3, 2012

(30) Foreign Application Priority Data
Feb. 5, 2010 (JP) 2010-024350

(51) Int. Cl. G01N 21/89; G01J 3/42

(52) U.S. Cl. 356/300; 356/237.5

(57) ABSTRACT

In an optical inspection for patterned media for hard disks, a pattern inspection device is provided for inspecting patterns without being susceptible to variations in film thickness and film quality of an underlying film, the device includes optical characteristics detection means for detecting optical characteristics of multilayers by processing, upon the reflected light being dispersed and detected by the spectroscopic detection means, the reflected light from a non-patterned region on the substrate, and processing a detection signal corresponding to, and detecting optical characteristics of, the reflected light from the patterns including the multilayers; and pattern inspection means for inspecting the patterns formed on the multilayers, by viewing, upon the detection of the optical characteristics by the optical characteristics detection means, information on the optical characteristics of the reflected light from the multilayers, and processing information on the optical characteristics of the reflected light from the patterns including the multilayers.

### TECHNICAL FIELD

The present invention relates to the inspection for a process of forming indented patterns on surfaces of hard-disk storage media and the like, and to the inspection for these formed patterns. More particularly, the invention is directed to a pattern inspection method and related device for inspecting geometrical defects and deformation in the formed patterns and dimensions of the patterns.

### BACKGROUND ART

The capacities of hard disks, one type of recording media used in computers, are becoming increasingly large in recent years. Improving the density required for recording on one disk is essential to increasing the amount of information recorded thereupon. Employing patterned media, or media with patterns formed on the disk surface, is a promising scheme since these media allow significant improvement of recording density, compared with conventional disk media. Nano-imprint technology that enables the formation of low-cost nanoscale patterns is used to form such patterned media. Nano-imprint technology is a technique for pressing a previously created template (or stamp) against a material and reproducing the same pattern as that of the template. The use of this technique is being considered as a method of forming optical elements in addition to patterned media for hard-disk drive use, or as an alternative in an exposure process associated with semiconductor fabrication.

The pattern sizes used for patterned media are usually up to 100 nm, which is as small as several fractions of the wavelength of visible light. Since this dimensional level is beyond the resolution limits of such ordinary optical devices as microscopes, the shapes of these patterns cannot be directly analyzed with these optical devices. Because of this, geometry measurement with an atomic force microscope (AFM), a scanning electron microscope (SEM), or the like, or near-field optical detection with a scanning near-field optical microscope (SNOM) is likely to be useable, but in terms of throughput, rapid viewing of a wide area is impossible even by using these microscopes.

Meanwhile, an optical type of inspection device based on the principles of scatterometry is applied to semiconductor pattern-forming process control. This optical type of inspection device uses a control pattern, called TEG (Test Element Group), to detect line-and-space and other periodical patterns, the TEG being disposed beforehand in a non-product region on a semiconductor wafer to be inspected. In this detection technique, geometry of patterns to be viewed is analyzed by, for example, irradiating with white light the periodical patterns within a region of at least about 50 micrometers square (μm) and then detecting spectral characteristics of the light reflected. Patent Document 1 discloses patterned media inspection based on such a technique. According to Patent Document 1, scatterometry can be used to measure/evaluate the geometry of periodical patterns by analyzing reflection intensity of detected light. Patent Document 1 also says that when a servo information region is present on the sample, evaluation with scatterometry is likewise possible by analyzing acquired data.

In addition, Patent Document 2 describes a method of applying a scatterometry-based detection tool to semiconductor defect classification.

### PRIOR ART LITERATURE

### Patent Documents

Patent Document 1: JP-A-2007-133985
Patent Document 2: U.S. Pat. No. 6,639,663

### SUMMARY OF THE INVENTION

### Problems to be Solved by the Invention

To analyze a pattern shape with scatterometry, it has traditionally been necessary to accurately measure optical characteristics data on underlying layers beforehand, inclusive of the pattern layer. Measuring the optical characteristics data on each layer generally involves measuring optical constants with ellipsometry, but to implement this measurement, a uniform film having a planar region of at least several tens of micrometers square needs to be present on the sample. For semiconductor inspection, therefore, the prior art has used either a special wafer prefabricated for optical measurement, or a uniform film region previously provided on the foregoing TEG pattern or the like.

Currently prevalent patterned media for hard-disk drives (HDDs), however, are as small as 2.5 or 3.5 inches in diameter, compared with currently prevalent semiconductor wafers of 12 inches. In addition, an available area on an most inner region of such a patterned medium is small since this region needs to be used for a rotational axis. For these reasons, the TEG pattern is difficult to provide for inspection. Even for patterned media, therefore, it has been necessary to measure optical characteristics data using a prefabricated special disk for optical measurement. Because of the existence of fabrication process errors and other factors, however, matching between the optical characteristics in actual products and the data measurements with the special disk for optical measurement is not always guaranteed, which in turn is estimated to cause pattern size measurement errors.

Additionally, measuring a pattern geometry with scatterometry requires allowing for measurement errors due to variations in underlying-film thickness. If the variations in underlying-film thickness are similar to shape-specific variations in the spectral waveform of the patterns, the above-discussed technique uses the uniform-film region of the TEG pattern to measure the underlying-film thickness. Even in this case, however, providing the TEG pattern for inspection is difficult for the foregoing reasons.

### Means for Solving the Problems

In order to solve these problems, the present invention provides, as an aspect thereof, a pattern inspection device including: rotary table unit constructed to rotate with a sample substrate mounted thereupon, the substrate having patterns formed on multilayers; illumination unit which irradiates the sample substrate mounted on the rotary table unit with illumination light; spectroscopic detection unit which disperses and detects the light reflected from a region light-irradiated by the illumination means; optical characteristics detection unit which detects optical characteristics of the multilayers by processing, upon the reflected light being dispersed and detected by the spectroscopic detection unit, a detection signal corresponding to the reflected light from a non-patterned region on the substrate, the optical characteristics detection unit further processing a detection signal corresponding to, and detecting optical characteristics of, the reflected light from the patterns including the multilayers; and pattern inspection unit which inspects the patterns formed on the multilayers, by viewing, upon the detection of the optical characteristics by the optical characteristics detection unit, information on the optical characteristics of the reflected light from the multilayers, and processing information on the optical characteristics of the reflected light from the patterns including the multilayers.

In order to solve these problems, the present invention provides, as another aspect thereof, a method for inspecting patterns formed on multilayers of a substrate, the method including: irradiating with light a region free from the patterns formed on the multilayers; dispersing and detecting the light reflected from the light-irradiated non-patterned region; detecting optical characteristics of the multilayers from a signal obtained by the detection and dispersion of the light reflected from the non-patterned region; irradiating a patterned region with light; dispersing and detecting the light reflected from the light-irradiated and patterned region; detecting optical characteristics including those of the patterns and the multilayers, from a signal obtained by the detection and dispersion of the light reflected from the patterned region; and inspecting the patterns formed on the multilayers, by processing information on the optical characteristics including those of the patterns and the multilayers, by use of information on the optical characteristics of the multilayers, the former information being obtained from the signal detected after the dispersion of the light reflected from the patterned region, and the latter information being obtained from the signal detected after the dispersion of the light reflected from the non-patterned region.

In order to solve these problems, the present invention provides, as yet another aspect thereof, a method for inspecting patterns formed on multilayers of a substrate, the method including: irradiating a multilayer-patterned region with light; dispersing and detecting the light reflected from the light-irradiated, patterned region; removing wavelength components susceptible to the multilayers, from a signal of the dispersed and detected light reflected from the patterned region; and inspecting the patterns by processing the signal cleared of the wavelength components susceptible to the multilayers.

### Effects of the Invention

The present invention accurately and easily identifies defects present on a sample, such as a patterned medium, that has very small patterns formed thereupon. The invention also measures sizes of the patterns accurately and easily. The invention therefore contributes to stabilizing processes and improving production yields.

### BRIEF DESCRIPTION OF THE DRAWINGS

FIG. 1 is a block diagram showing a schematic configuration of an optical system according to a first embodiment of the present invention;

FIG. 2 is an external view of a patterned medium as an example of a sample to be inspected, showing the patterned medium in plan view (a) and in section (b);

FIG. 3 is a flow diagram showing a flow of an inspection process for the patterned medium in the first embodiment;

FIG. 4 is a flow diagram showing a flow of a single-sided disk inspection process in the first embodiment;

FIG. 5 is a sectional view showing a servopattern neighboring region of the patterned medium;

FIG. 6 is a flow diagram showing a flow of a patterned-medium inspection process in a second embodiment;

FIG. 7 shows graphs relating to a uniform region without a pattern formed thereupon, graph (a) showing changes in multiple points of spectral waveform data in the uniform region without a pattern formed thereupon, and graph (b) showing changes in a waveform change ratio of the uniform region without a pattern formed thereupon;

FIG. 8 is a graph that shows changes in multiple points of spectral waveform data in a region with patterns formed thereupon; and

FIG. 9 is a front view of a screen with inspection results displayed in the second embodiment.

### MODES FOR CARRYING OUT THE INVENTION

A method and related device using a fitting process, and a method and related device using a spectral waveform analyzing process will be described as embodiments of the present invention.

### First Embodiment

First, a method using a fitting process is described below as a first embodiment.

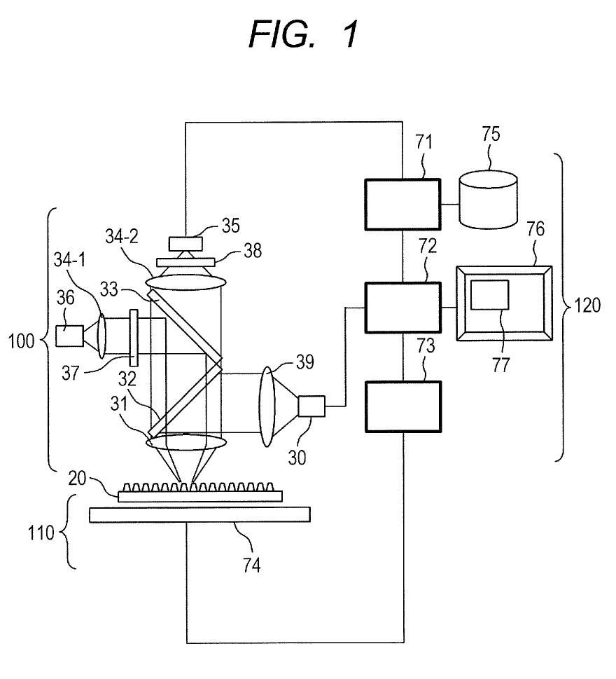

An example of a disk inspection device according to the present invention is shown in FIG. 1.

The disk inspection device according to the present invention includes an illumination/detection optical system 100, a stage system 110, and a signal-processing/control system 120.

The illumination/detection optical system 100 includes a light source 36, a converging lens 34-1, a polarizer 37, half mirrors 32, 33, an objective lens 31, a converging lens 34-2, an analyzer 38, a spectroscopic detector 35, a converging lens 39, and a camera 30.

The stage system 110 is equipped with a rotatable scanning stage 74 and a chuck (not shown) that holds a sample in a sandwiched condition.

The signal-processing/control system 120 includes waveform analyzing means 71, integrating means 72, a controller 73, a database 75, and input/output means 76 with a display screen 77.

The scanning stage 74 may be either a rotary stage that only rotates, or an Re-type stage that scans the sample in a radial direction while rotationally scanning the sample.

In addition, the light source 36 in the illumination/detection optical system 100 can be either a lamp that emits white light, a lamp light source that emits invisible light such as ultraviolet light or infrared light, or an optical system that uses a laser light source having a specific wavelength(s). Furthermore, a polarizing element that gives polarization characteristics to the illumination light emitted from the light source 36 may be inserted between the light source 36 and the half mirror 33.

Moreover, the spectroscopic detector 35 may be either a spectroscopic detector for detecting the white light, wavelength by wavelength, that includes ultraviolet light, or a detector for detecting reflected light of a specific single wavelength or a plurality of wavelengths.

Next, operation of each element is described below.

The sample (patterned medium) that is to be inspected is placed on the rotary stage 74 constructed so that the entire surface of the sample can be viewed, and the controller 73 allows any position on the sample surface to be viewed. Light that has been emitted from the light source 36 towards a viewing point on the sample 20 is converged by the converging lens 34-1, then admitted as parallel beams into the polarizer 37, and reflected by the half mirror 33 via the polarizer 37. This reflected light is next passed through the half mirror 32, and the converged beams of light are emitted through the objective lens 31. The emitted light is reflected from the surface of the sample 20.

Of the light thus reflected by the sample 20, the reflected light that has entered the objective lens 31 is routed back through the objective lens 31, the half mirror 32, and the half mirror 33, in that order, and then converged by the converging lens 34-2. After this, desired components of the reflected light are filtered by the analyzer 38 and detected by the photodetector 35. In such a configuration, in a case that the light source 36 is a white light source, the analyzer 38 is a polarizer, and the photodetector 35 is a spectroscope, the photodetector 35 detects a spectral waveform appropriate for the pattern shape and optical characteristics of the sample 20. The detected spectral waveform is sent to the waveform analyzing means 71, and by referring the database 75 relating to optical constants and past spectral waveforms, a desired film thickness and a pattern geometry as well as optical constants are calculated from the detected waveform.

In addition, if the light that has been reflected by the half mirror 32 is converged with the converging lens 39, a camera image at the same position as that of the spectral data acquired by the spectroscope 35 can be obtained by imaging with the camera 30. The integrating means 72 then associates the spectral data and the image data with each other, thus enabling a whole-surface spectral waveform of the sample 20 to be inspected. Inspection results are displayed as a graph or a figure on the display screen 77 of the input/output means 76, with a defect distribution and others being displayed on a map.

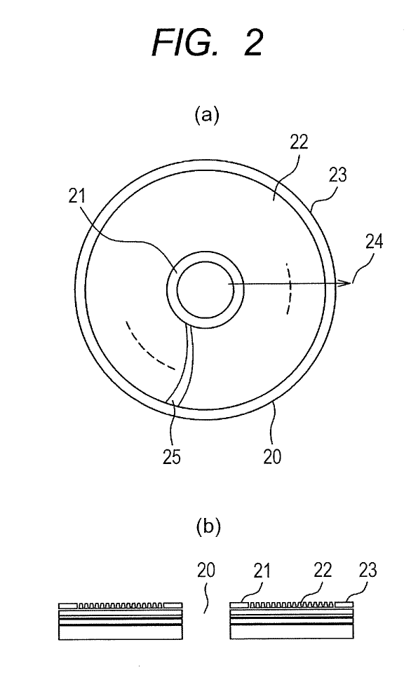

FIG. 2 shows the patterned medium 20 as an example of a sample to be inspected. A plan view of the patterned medium is shown as (a), and a sectional view thereof is shown as (b). An most inner region 21 and an most outer region 23 are uniform regions without a pattern, and a pattern region 22 with patterns arranged thereupon is interposed between the regions 21, 23. When a detection position is moved using the rotary stage 74 of FIG. 1 in order to conduct inspection, scanning the sample in a moving direction 24 for radial movement of the detection system while rotating the sample similarly to an ordinary HDD, is the fastest.

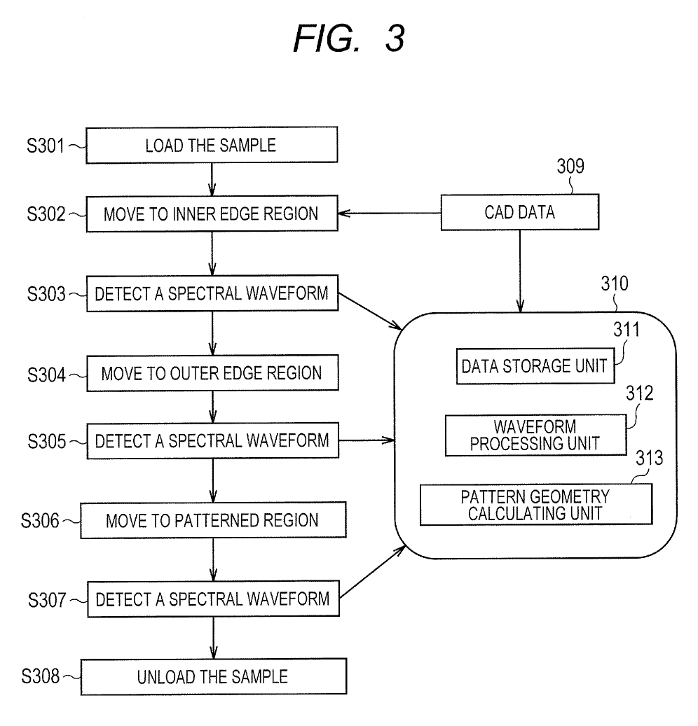

FIG. 3 is a flow diagram showing a flow of the inspection process for the patterned medium in the first embodiment. First, either an intermediate process step relating to the patterned medium to be inspected, or a final product is taken as the sample 20. The sample 20 is loaded onto the rotary stage 74 of the inspection device (step S301). Next, CAD data 309 that is media design information is referred to and moving means (not shown) moves the illumination/detection optical system 100, thereby the detection position of the illumination/detection optical system 100 comes into the most inner region 21 of the sample (step S302). Since the most inner region 21 is a uniform region without a pattern, the illumination/detection optical system 100 detects a spectral waveform at more than one measuring point on that region while the rotary stage 74 is rotating (step S303).

The detected waveform is sent to and temporarily stored into an internal data storage unit 311 for a processing system 310 provided in the waveform analyzing means 71, and is then transferred from the data storage unit 311 to a waveform analyzing unit 312, in which the waveform is analyzed. Through the analysis, the film thicknesses and optical constants (complex indices of refraction) of each layer on the uniform region are calculated and then stored into the data storage unit 311.

Next, likewise the moving means (not shown) moves the illumination/detection optical system 100, thereby the detection position of the illumination/detection optical system 100 comes into the most outer region 23 of the sample (step S304). Since the most outer region 23 is also a uniform region without a pattern, the illumination/detection optical system 100 detects a spectral waveform at more than one measuring point on that region while the rotary stage 74 is rotating (step S305). The detected waveform is sent to and temporarily stored into the internal data storage unit 311 of the processing system 310 and transferred from the data storage unit 311 to the waveform analyzing unit 312, in which the waveform is analyzed. Through the analysis, the film thicknesses and optical constants (complex indices of refraction) of each layer on the uniform region are calculated and then stored into the data storage unit 311.

The film thicknesses and optical characteristics of regions other than the patterned regions at the sample edges are obtained from the above results, and the film thicknesses and optical characteristics of the sample on its entire surface are calculated from the obtained data by approximation.

The waveform analysis that the waveform analyzing unit 312 executes is described in detail below. It is generally known that ellipsometry is used to calculate the thicknesses and optical constants of the films of a multilayered sample. The present embodiment also uses substantially the same means to determine a layer structure. When the sample region to be inspected is a non-patterned region, a theoretical layer structure model based on design data is first constructed.

Fundamental data relating to materials to be used for each layer, such as optical characteristics, is databased in beforehand so that later reference can be made to the data. The actually detected waveform is compared with the waveform that has been calculated from the design data and the fundamental data of the database, and then a fitting process is conducted to fit both waveforms by repeatedly varying the film thicknesses and optical characteristics of each layer. Independent fitting may be done for one detection point, or parallel fitting may be done for a plurality of points. In this latter case, since the optical characteristics are estimated to little change in one plane, fitting will be more efficient if the optical characteristics are first determined and then the film thicknesses at each point in the plane are determined.

Next, the moving means (not shown) moves the illumination/detection optical system 100, thereby moving the detection position of the illumination/detection optical system 100 to a pattern region having a pattern (step S306). After this, while rotating the rotary stage 74, the inspection device activates the moving means (not shown) to move the illumination/detection optical system 100 in a radial direction of the sample 20 at a constant speed, thus making the optical system 100 detect a spectral waveform at the pattern region 22 (step S307). The detected waveform is sent to and temporarily stored into the internal data storage unit 311 for the processing system 310 provided in the waveform analyzing means 71, and transferred from the data storage unit 311 to the waveform analyzing unit 312, in which the waveform is then analyzed. After this analysis, a pattern geometry calculating unit 313 calculates the pattern geometry by scatterometry (step S307).

In this sequence, pattern-measuring accuracy can be improved by using the film thicknesses of each layer and optical constants that were calculated in steps S303 and S305 and stored into the data storage unit 311. After detection of the entire pattern region 22 to be inspected, the illumination/detection optical system 100, as driven by the moving means (not shown), moves to a stand-by region. After the illumination/detection optical system 100 has moved to the stand-by region, the rotation of the rotary stage 74 is stopped and then the sample 20 is unloaded from the inspection device (step S308) to complete the inspection of one sample.

While it has been described above for convenience' sake that the detection is conducted at the most inner region 21, the most outer region 23, and the pattern region 22, in that order, the inspection sequence can be changed for faster scanning of the detection position by assigning a sufficient data storage capacity to the data storage unit 311. In addition, although the most inner region and the most outer region have been detected as pattern-less uniform regions, the detection may be conducted at other regions, for example, in a case of a single-sided disk sample, an unpatterned lower-surface region. Furthermore, even if the region to be inspected is an intermediate region, provided that it is not a pattern region, the intermediate region may be detected. Moreover, after the calculation of the film thicknesses and optical characteristics by the waveform analyzing unit 312, the film thicknesses and optical characteristics of the sample may be approximated by interpolation after calculating an in-plane distribution of the film thicknesses and optical characteristics.

While in the above embodiment, the most inner region 21, the most outer region 23, and the pattern region 22 have been discriminated from one another by referring the CAD data 309, an image of the sample may be displayed on the screen 77 of the input/output means 76 so that each region can be specified on the screen 77.

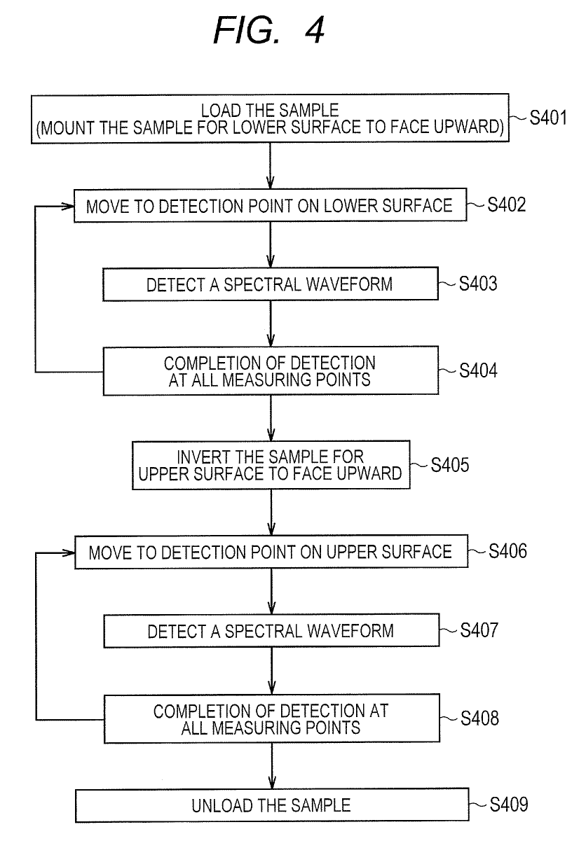

A flow of an inspection process using a non-patterned backside surface of a single-sided disk, that is, a disk with patterns formed only on one side is described below using FIG. 4. First, the sample is loaded into the inspection device (step S401). At this time, the sample is loaded so that the non-patterned surface (backside surface) faces towards the detection optical system. Next, the rotary stage 74 is rotated to rotate the sample. While the sample is rotating, the moving means (not shown) moves the illumination/detection optical system 100 to move the detection position thereof to a detection point on the sample (step S402). Even for the non-patterned surface of the one-sided disk, if the disk has substantially the same magnetic materials layer structure as that of the patterned surface, a spectral waveform of the non-patterned surface is detected at a plurality of points. In this case, the detection points are arranged so that in-plane interpolation on the whole surface of the disk is possible.

Next, the illumination/detection optical system 100 detects the spectral waveform (step S403). A processing sequence relating to a signal obtained by the detection of the spectral waveform is the same as the sequence described using the flow diagram of FIG. 3. After a magnetic materials layer distribution of the non-patterned surface of the single-sided disk has been detected in this way (step S404), the sample is inverted for the patterned upper-surface side to face the detection optical system (step S405), and then the moving means not shown moves the illumination/detection optical system 100 to move the detection position thereof to a detection point on the upper surface of the sample (step S406). Then a spectral waveform on the patterned surface side (upper surface) is detected (step S407). In this sequence, inspection accuracy can be improved by using a magnetic materials layer distribution of an appropriate in-plane region of the non-patterned surface as an underlying film of a resist pattern. The spectral waveform detection is continued until detection at all measuring points has been completed, and upon completion of the measurement at all measuring points (step S408), the sample is unloaded (step S409). This completes the inspection process.

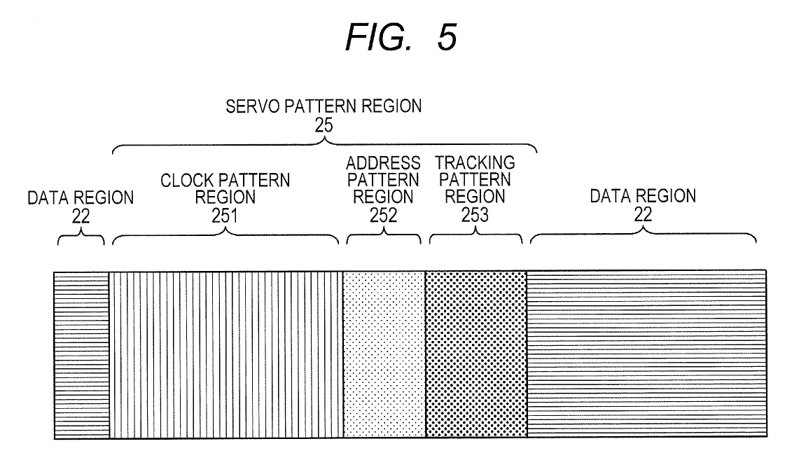

A neighborhood of a servo pattern region 25 on the patterned medium shown in FIG. 2 is described below using FIG. 5. FIG. 5 is a schematic sectional view of the servo pattern region 25 on the patterned medium shown in FIG. 2, the section of the region 25 being shown as a single-layer structure by omitting a multi-layer structure by the differences in the kinds of materials in a perpendicular direction of the sample. The servo pattern region 25 is formed in plurality of areas on the patterned medium 20. The servo pattern is an important pattern that holds information necessary to conduct position control required for data read/write operations during magnetic disk recording. The servo pattern region 25 includes a clock pattern region 251, an address pattern region 252, and a tracking pattern region 253.

During the inspection of the servo pattern region 25, it is also imperative to eliminate any influences of the underlying film. Since the servo pattern, as opposed to a periodic pattern, varies from location to location, accurate inspection of this pattern is impossible just by simple comparison with a reference spectral waveform. The servo pattern region can however be inspected as accurately as a data region that is a periodic pattern, if any changes in the wavelength of the spectral waveform are compared with those due to changes in a state of the underlying film, or with those ascribed to changes in mode and to defects in servo pattern.

### Second Embodiment

A method that uses spectral waveform analysis is described below in a second embodiment. The inspection device used in the present embodiment has substantially the same configuration as that described in the first embodiment and shown in FIG. 1, and only different is a technique relating to the waveform analysis in the waveform analyzing means 71.

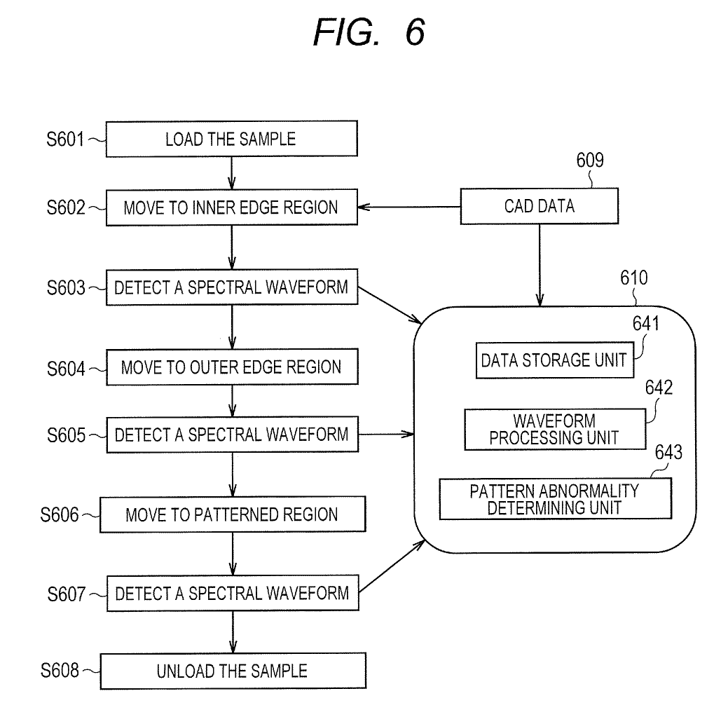

FIG. 6 shows a flow of a patterned-medium inspection process in the second embodiment of the present invention. First, as in the first embodiment, a patterned medium to be inspected is taken as a sample 20, and the sample 20 is loaded onto the rotary stage 74 of the inspection device (step S601). Next, CAD data 609 that is media design information is referred to and moving means (not shown) moves the illumination/detection optical system 100, thereby moving the detection position of the illumination/detection optical system 100 to the most inner region 21 of the sample (step S602). Since the most inner region 21 is a uniform region without a pattern, the illumination/detection optical system 100 detects a spectral waveform at more than one measuring point on that region while the rotary stage 74 is rotating (step S603). The detected waveform is sent to and temporarily stored into an internal data storage unit 641 for a processing system 610 provided in the waveform analyzing means 71, and transferred from the data storage unit 641 to a waveform analyzing unit 642, in which the waveform is then analyzed. Details of signal processing in the waveform analyzing unit 642 will be described later herein.

Next, the moving means (not shown) moves the illumination/detection optical system 100, thereby moving the detection position of the illumination/detection optical system 100 to the most outer region 23 of the sample (step S604). Since the most outer region 23 is also a uniform region without a pattern, the illumination/detection optical system 100 detects a spectral waveform at more than one measuring point on that region while the rotary stage 74 is rotating (step S605). The detected waveform signal is likewise sent to and temporarily stored into the internal data storage unit 641 for the processing system 610 and transferred from the data storage unit 641 to the waveform analyzing unit 642.

The waveform analyzing unit 642 analyzes spectral waveforms obtained on the pattern-less uniform regions of the sample, and calculates change ratios of each wavelength. The waveform analyzing unit next identifies significantly changing wavelength regions from the calculated change ratios. This allows one to understand the way the spectral waveforms are changing in the pattern-less uniform regions 21 and 23 of the sample. The data indicating the wavelength-specific change ratios, and the data indicating the significantly changing wavelength regions are both stored into the data storage unit 641.

Next, the moving means (not shown) moves the illumination/detection optical system 100, thereby moving the detection position of the illumination/detection optical system 100 to a pattern region 22 having a pattern (step S606). After this, while rotating the rotary stage 74, the inspection device activates the moving means (not shown) to move the illumination/detection optical system 100 in a radial direction of the sample 20 at a constant speed, thus making the optical system 100 detect a spectral waveform at the pattern region 22 (step S607).

The detected waveform is next subjected to the analysis in the internal waveform-analyzing unit 642 of the waveform analyzing means 71. During the analysis, changes in waveform in a working wavelength range, which is a region exclusive of the wavelength region of the high spectral-waveform change ratio already calculated and stored in the data storage unit 641, are analyzed in the waveform analyzing unit 642. The analytical results obtained are processed by a pattern abnormality determining unit 643. The pattern abnormality determining unit 643 conducts, for example, a pattern abnormality determination to determine whether a pattern abnormality is occurring on the detection region whose wavelength significantly changes in the working wavelength range.

After detection of the entire pattern region 22 to be inspected, the sample is unloaded from the inspection device (step S608). The inspection process for one sample is now complete.

While it has been described above for convenience' sake that the detection is conducted at the most inner region 21, the most outer region 23, and the pattern region 22, in that order, the inspection sequence can be changed for faster scanning of the detection position by assigning a sufficient data storage capacity to the data storage unit 641. Additionally, in accordance with the present embodiment, since there is no need to calculate the pattern shape itself, inspection can be completed rapidly in comparison with that based on the scatterometry described in the first embodiment. For example, if a sensor formed by multichanneling an electron multiplier tube that is a high-speed sensor is used as the spectroscopic detector 35, inspection can be completed very rapidly. For example, given a sensor speed of 4 MHz, a sample-rotating speed of 10,000 rpm, and a diameter of one detection region (called an inspection spot) of φ30 μm, an entire 2.5-inch disk surface can be inspected within about 4 seconds.

While in the above embodiment, the most inner region 21, the most outer region 23, and the pattern region 22 have been discriminated from one another by referring the CAD data 309, an image of the sample may be displayed on the screen 77 of the input/output means 76 so that each region can be specified on the screen 77.

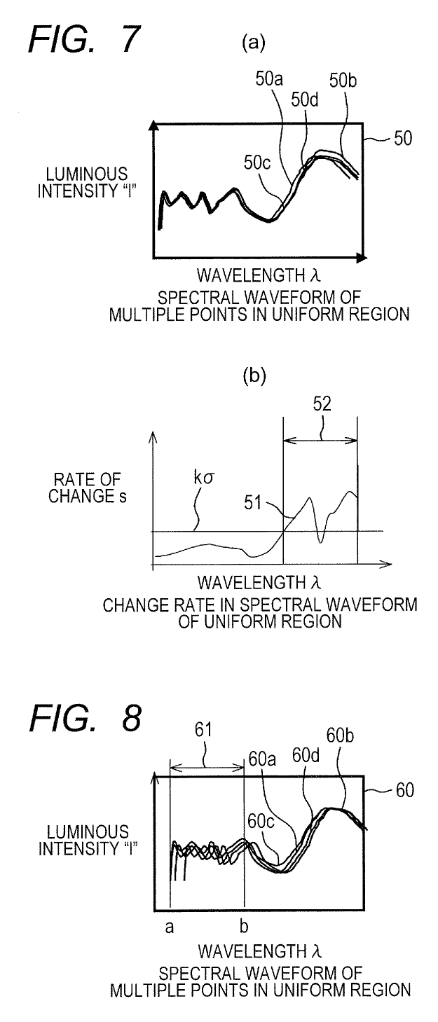

The waveform analysis in the waveform analyzing unit 642 is described in further detail below using FIG. 7. Referring to section (a) of FIG. 7, waveform 50 to be subjected to processing is expressed as, for example, including four measuring points of spectral waveform data, 50a to 50d, on the most inner region 21 and the most outer region 23. If these waveforms are each expressed as Iᵢ(λ), where i=1 to 4 and λ is a wavelength, the change ratios of each wavelength, S(λ), are given as follows by formula 1:

$$S ( λ ) = \frac{1}{n - 1} {\sum }_{i = 1}^{n} {( \overline{I} ( λ ) - {I}_{i} ( λ ) )}^{2} , \overline{I} ( λ ) = \frac{1}{n} {\sum }_{i = 1}^{n} ( {I}_{i} ( λ ) ) \qquad ( Formula 1 )$$

Formula 1 is used to calculate wavelength-specific dispersion in the amount of light I, the dispersion being equal to a square of a standard deviation σ. A wavelength region 52 having a significantly high change ratio is determined from a waveform 51 indicating the change ratio S in section (b) of FIG. 7. Here, a threshold level of a significant change ratio is defined as, for example, kσ (“k” times of the standard deviation), and the coefficient “k” is determined by process conditions, a state of the sample, and other factors.

Next, the abnormality determining unit 643 is used to determine whether a pattern is abnormal using the processing results within the waveform analyzing unit 642 which received the spectral waveform detection signal corresponding to the pattern region 22 in step S607. Pattern abnormality determination to be executed is described in detail below using FIG. 8. Waveform 60 to be subjected to processing is expressed as, for example, including four measuring points of spectral waveform data, 60a to 60d, on the pattern region 22. In addition, let these waveforms be each expressed as Iᵢ(λ), where i=1 to 4 and λ is a wavelength. A wavelength region 61 exclusive of a region corresponding to such a wavelength region 52 as shown in section (b) of FIG. 7, is set, with the region 52 being high in the change ratio on the non-patterned uniform most inner region 21 and most outer region 23. Here, let wavelengths of the wavelength region 52 range between λ=a and λ=b, and let a pattern abnormality determination value E(i) be given by formula 2. Formula 2 represents a deviation from a mean value in the spectral waveform on the wavelength region 61, wherein the deviation is called the mean-square error.

$$E ( i ) = \frac{1}{b - a} {\sum }_{λ = a}^{1} {( \overline{I} ( λ ) - {I}_{i} ( λ ) )}^{2} , \overline{I} ( λ ) = \frac{1}{n} {\sum }_{i = 1}^{n} ( {I}_{i} ( λ ) ) \qquad ( Formula 2 )$$

If the waveform exceeds a certain threshold level by comparison with the pattern abnormality determination value E(i), it is determined that a pattern abnormality has occurred on that detection region.

Alternatively, while using S calculated in formula 1, determination value E′(i) shown in formula 2 may be used.

For the sake of convenience in description, the number of spectral waveform detection points in the present embodiment has been set to be four on the most inner region 21, the most outer region 23, and the pattern region 22 each, but it goes without saying that the number of detection points during actual inspection is determined by the disk in-plane density and throughput required for the inspection. Additionally, while the wavelength regions 52, 61 have been set to be one spatial interval wide, they may be two intervals wide or more. Furthermore, the wavelength region 61 may be a full-wavelength region when E′(i) in formula 3 is used.

$${E}^{′} ( i ) = \frac{1}{b - a} {\sum }_{λ = a}^{b} [ {( \overline{I} ( λ ) - {I}_{i} ( λ ) )}^{2} / S ( λ ) ] \qquad ( Formula 3 )$$

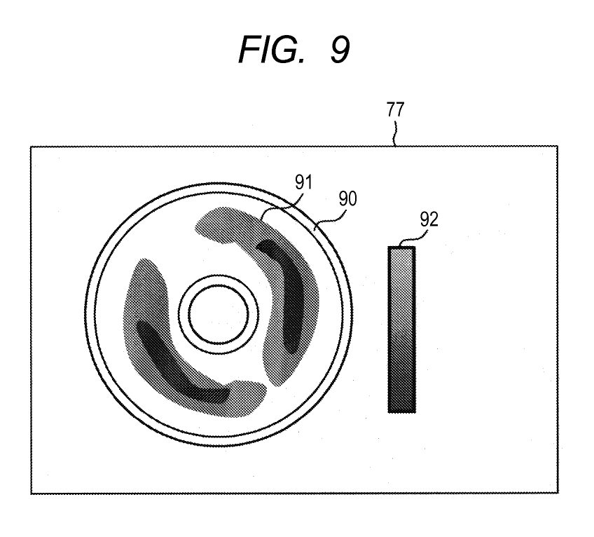

FIG. 9 shows an example in which inspection results in the present embodiment are displayed on the screen 77 of the input/output unit 76. On the screen 77, layer-by-layer distribution regions or a pattern variations map 90 is displayed for the disk surface 22 of the sample 20. As shown, a variation-dependent distribution 91 for each region is presented in accordance with legend 92, thereby making it possible to read in-plane uniformity of the patterns and any impacts of the underlying layers. In addition, conducting comparisons in groups of samples allows one to determine whether the sample contains a specific succession of defects or contains the characteristic defects of the sample, and the determination in turn allows in-process stamper defect existence determination. It is important to early detect stamper defects, since these defects cause a large number of defects.

### INDUSTRIAL APPLICABILITY

The present invention can be applied to inspection devices that during the formation of indented patterns on the surfaces of hard-disk storage media, inspect geometrical defects and deformation in the formed patterns and dimensions of the patterns.

### DESCRIPTION OF REFERENCE NUMBERS

20 . . . Sample (Patterned medium), 30 . . . Camera, 31 . . . Objective lens, 32, 33 . . . Half mirrors, 34-1, 34-2, 39 . . . Converging lenses, 35 . . . Spectroscopic detector, 36 . . . Light source, 37 . . . Polarizer, 38 . . . Analyzer, 71 . . . Waveform analyzing means, 72 . . . Integrating means, 73 . . . Controller, 74 . . . Rotary stage, 75 . . . Database, 76 . . . Input/output means, 310, 610 . . . Processing systems, 311, 641 . . . Data storage units, 312, 642 . . . Waveform analyzing units, 313 . . . Pattern geometry calculating unit, 643 . . . Pattern abnormality determining unit.

1. A pattern inspection device comprising:
rotary table unit constructed to rotate with a sample substrate mounted thereupon, the substrate having patterns formed on multilayers;
illumination unit which irradiates the sample substrate mounted on the rotary table unit with illumination light;
spectroscopic detection unit which disperses and detects the light reflected from a region light-irradiated by the illumination means;
optical characteristics detection unit which detects optical characteristics of the multilayers by processing, upon the reflected light being dispersed and detected by the spectroscopic detection unit, a detection signal corresponding to the reflected light from a non-patterned region on the substrate, the optical characteristics detection unit further processing a detection signal corresponding to, and detecting optical characteristics of, the reflected light from the patterns including the multilayers; and
pattern inspection unit which inspects the patterns formed on the multilayers, by viewing, upon the detection of the optical characteristics by the optical characteristics detection unit, information on the optical characteristics of the reflected light from the multilayers, and processing information on the optical characteristics of the reflected light from the patterns including the multilayers.

2. The pattern inspection device according to claim 1,
wherein the pattern inspection unit, by conducting a fitting process, derives film thickness and optical characteristics of the multilayers from a signal obtained by dispersing and detecting the light reflected from a region not including the patterns, and by scatterometry with information on the film thickness and optical characteristics of the multilayers obtained, calculates a geometry of the patterns from a signal obtained by dispersing and detecting the light reflected from a region including the patterns.

3. The pattern inspection device according to claim 2,
wherein the pattern inspection unit derives, from the film thickness and optical characteristics of the multilayers on non-patterned regions present at both sides of the patterned region, an in-plane distribution of the multilayers formed on the substrate, and then derives, by interpolation, film thickness and optical characteristics of the patterned region from the derived in-plane distribution.

4. The pattern inspection device according to claim 1,
wherein the pattern inspection unit calculates change ratios of quantities of light for each wavelength, based on the dispersed and detected light reflected from the non-patterned region, excludes the light reflected from a region corresponding to a wavelength region of a region exceeding a previously set threshold level in terms of the change ratio of the quantity of light, from the light reflected from a region with the patterns formed thereupon, and inspects the patterns of the patterned region by use of the reflected light of the wavelength region, left after the exclusion.

5. A method for inspecting patterns formed on multilayers of a substrate, the method comprising:
irradiating with light a region free from the patterns formed on the multilayers;
dispersing and detecting the light reflected from the light-irradiated non-patterned region;
detecting optical characteristics of the multilayers from a signal obtained by the detection and dispersion of the light reflected from the non-patterned region;
irradiating a patterned region with light;
dispersing and detecting the light reflected from the light-irradiated patterned region;
detecting optical characteristics including those of the patterns and the multilayers, from a signal obtained by the detection and dispersion of the light reflected from the patterned region; and
inspecting the patterns formed on the multilayers, by processing information on the optical characteristics including those of the patterns and the multilayers, by use of information on the optical characteristics of the multilayers, the former information being obtained from the signal detected after the dispersion of the light reflected from the patterned region, and the latter information being obtained from the signal detected after the dispersion of the light reflected from the non-patterned region.

6. The pattern inspection method according to claim 5, further comprising:
by conducting a fitting process, deriving film thickness and optical characteristics of the multilayers from a signal obtained by dispersing and detecting the light reflected from a region not including the patterns; and
by means of scatterometry with information on the film thickness and optical characteristics of the multilayers obtained, calculating a geometry of the patterns from a signal obtained by dispersing and detecting the light reflected from a region including the patterns.

7. The pattern inspection method according to claim 6, further comprising:
deriving, from the film thickness and optical characteristics of the multilayers on non-patterned regions present at both sides of the patterned region, an in-plane distribution of the multilayers formed on the substrate; and
deriving, by interpolation, film thickness and optical characteristics of the patterned region from the derived in-plane distribution.

8. The pattern inspection method according to claim 5, further comprising:
calculating change ratios of wavelength-specific quantities of light, based on the dispersed and detected light reflected from the non-patterned region;
excluding the light reflected from a region corresponding to a wavelength region of a region exceeding a previously set threshold level in terms of the change ratio of the quantity of light, from the light reflected from a region with the patterns formed thereupon; and
inspecting the patterns of the patterned region by use of the reflected light of the wavelength region, left after the exclusion.

9. A method for inspecting patterns formed on multilayers of a substrate, the method comprising:
irradiating a multilayer-patterned region with light;
dispersing and detecting the light reflected from the light-irradiated, patterned region;
removing wavelength components susceptible to the multilayers, from a signal of the dispersed and detected light reflected from the patterned region; and
inspecting the patterns by processing the signal cleared of the wavelength components susceptible to the multilayers.

10. The pattern inspection method according to claim 9, wherein the wavelength components susceptible to the multilayers are extracted from a signal obtained by irradiating with light a region free from the patterns formed on the multilayers, dispersing the light reflected from the non-patterned region, and detecting the reflected light.

11. The pattern inspection method according to claim 10, further comprising:
calculating a mean square error from a spectral waveform signal obtained by removing the wavelength components susceptible to the multilayers;
comparing the calculated mean square error with a previously set threshold level; and
detecting abnormality of the patterns from a result of the calculation.
